(19) United States
(12) Patent Application Publication
(10) Pub. No.: US 2009/0047098 A1
(43) Pub. Date: Feb. 19, 2009

(54) Multi-Prong Push Pin Apparatus

(76) Inventor: Timothy Alan Darling, Casper, WY (US)

Correspondence Address: Roger A. Jackson, Esq., Suite G-7, 1115 Grant Street, Denver, CO, 80203-2399, US

(21) Appl. No.: 11/838,220

(22) Filed: Aug. 13, 2007

(51) Int. Cl. F16B 15/00

(52) U.S. Cl. 411/457; 411/469

(57) ABSTRACT

A pushpin and method of use for the pushpin for inserting into a surface and remaining adjacent to the surface, the pushpin includes a body having a body longitudinal axis, the body also including a first end portion and a second end portion, the body also having a middle portion disposed between the first end portion and the second end portion wherein the middle portion is sized and configured for manual grasping. Further included in the pushpin are at least three tines, each of the tines includes a proximal end portion and an opposing distal end portion with a lengthwise axis spanning therebetween, wherein each tine proximal end portion is adjacent to the second end portion, wherein each lengthwise axis is substantially parallel to the longitudinal axis and each of the tines are positioned substantially equidistant to one another.

### TECHNICAL FIELD

The present invention generally relates to an apparatus for removably engaging an article from a surface. More particularly the present invention is a multi pronged pushpin to removably engage the article that can include paper(s), string, wire, holiday lights, and the like.

### BACKGROUND OF INVENTION

Pushpins, thumbtacks, and the like are known to include a head portion and one or more tines projecting from the head portion that are used to pierce into the article therethrough continuing to partially pierce into the surface for the support, display, suspension, or similar holding or retaining of the article. Typically, a thumbtack is used to pierce through the article defined as a sheet of paper and into the surface defined as a bulletin-board thus retaining the sheet of paper to the bulletin board for the visual perception of the sheet of paper.

While these previously known thumbtacks secured the articles they pierced though to the bulletin board, they commonly allowed the article to rotate freely about the single prong or tine. Furthermore, the tine or tines could easily succumb to excessive pushing inward or insertion force (toward the surface) by either bending, or slipping, or collapsing either ruining the pushpin and/or possibly causing injury to the user. Moreover, especially with a single tined pushpin, the pushpin cannot support a high load either parallel or traverse to the tine longitudinal axis. The typical pushpin, because of limitations in the configuration and materials of the body, cannot use a high impact means for creating the insertion pushing inward force—such as a hammer as against the body, without the high probability of collapsing of the tine(s) lengthwise or lateral bending of the tine(s), similar to a bent nail (wherein the nail lengthwise becomes nearly parallel to the surface) and/or the body fractures from the hammer impact resulting in possible injury to the user from body pieces hitting the user to the tine(s) bending, collapsing, or projecting unexpectedly from the fractured body. Next, the typical pushpin's use generally requires its tine or tines to be inserted directly perpendicular to the surface it is penetrating due to the body perpendicular flange surface contacting the surface in a substantially parallel manner to secure the article to the surface. Moreover, the prior art of pushpins is limited to the piercing of flat lightweight articles such as sheet(s) of paper for their visual perception, or the simple hanging of an article and not much more.

The desire of improving the pushpin arts has been somewhat addressed in the prior art and there are a number of inventions for improving the functionality of the pushpin. These previously known inventions that attempt to improve upon the pushpin have, for the most part, improved upon one area to the detriment of others, or they have improved the pushpin or a like device for a specific, limited function. Hence, these improvements tended to be limited in their application and use.

Prior art examples would be in U.S. Pat. No. 4,955,813 to Fochler that teaches the use of multiple tines being used to eliminate the rotation of the article relative to the surface, also to increase the load capacity, i.e., attaching a heavier article to the surface, and to further protect against the accidental tear of the pierced article by having multiple piercings in the article to lessen the bearing load at each piercing opening but having a very limited pushpin body configuration hampers the insertion or removal and general experience of the thumbtack by the user, in addition to requiring the thumbtack to be inserted perpendicular to the surface that it was penetrating.

Further, in U.S. Design Pat. No. D224,086 to Willis disclosed are multiple tines being used but the body is also not conducive for the ergometric ease of insertion or removal by a user's fingers. Other prior art such as U.S. Pat. No. 1,991,561 to Krantz, U.S. Pat. No. 4,897,007 to Chen et al., and U.S. Design Pat. No. D149,099 to Sweet do have a pushpin body configuration that is conducive to ergometric insertion and removal by a user's fingers, however, these inventions all disclose a single tine, the flaws of which are in the aforementioned discussion.

Other prior art such as U.S. Pat. No. 4,525,115 to Garner, Sr. has somewhat of an ergometric body, but is limited in its teaching to a multiple nesting pushpin element system for holding multiple articles upon one another in a stacked fashion. Continuing, in U.S. Design Pat. No. D458,117 to Larson and U.S. Design Pat. No. D466,937 to Kochlefl et al. all contain pushpin bodies disclosing a recess for supporting, for instance a wire there through the pushpin body and are ergometrically conducive to insertion and removal, however, these feature two sharp tines, the flaws of such are discussed herein and do not contain a flexible or high impact resistant body. Further, two tine pushpins only result in one way directional stability (in a single plane) while inserting the pushpin into the surface and only double the bearing load area in piercing through the article as compared to a single pushpin tine.

Another issue with the aforementioned prior art is safety concerns, in looking at the sharp pointed tine(s) that can cause injury to the user and various other objects during the insertion, removal, handling or use of the pushpin. Additionally, when using a driving means, such as a hammer, to force pushpins into the desired surface, the prior art tine(s) can bend or the head/body could fracture exposing the tine or tines as previously discussed. With the tines exposed and the head/body broken or shattered, potential injury to persons and objects is significantly increased. Furthermore, when attempting to insert a single tine or two tine pushpin where a greater force is required to insert the pushpin, the pushpin could lose its insertion lateral stability (moving uncontrollably parallel to the surface) become non-perpendicular with the surface and pinch or otherwise cause injury to the user or other objects from the pushpin body suddenly moving parallel to the surface in a fast and unexpected manner, i.e. sideways. In U.S. Design Pat. No. D458,117 to Larson and U.S. Design Pat. No. D466,937 to Kochlefl et al., disclosed are multiple tines that would help the insertion lateral stability as previously described, however, they are limited to two tines, which only add stability in a single plane laterally or parallel to the surface and do not teach the benefit from the characteristics of a tripodal (three tines) or more design, that helps to give omni-directional insertion lateral stability parallel to the surface, not just in a single plane as previously described with the use of two tines.

A further safety concern is the sharpness of the tine(s) of the pushpins. A pushpin should contain the bluntest possible tine or tines practicable to avoid unwanted cutting or puncturing the user of the pushpin while still being able to pierce the surface without the need for excessive insertion force. However, it is also desirable for a tine to penetrate the greatest variety of surface materials. Thus, a pushpin with the safety feature of rounded and not excessively sharp or pointed tines should be able to not require an excessively high insertion force to allow for the piercing of the greatest variety of surface materials possible. Thus pointing to the need for a high impact capable body, say for the use of a hammer is desirable. Prior art such as U.S. Pat. No. 4,955,813 to Fochler and U.S. Design Pat. No. D466,937 to Kochlefl et al. are examples of pushpins that can potentially harm the user or objects because of their sharp tipped tines needed to penetrate various surface materials. Prior art such as U.S. Pat. No. 1,051,310 to Cameron, as taught can sustain the impact of a hammer and could use more rounded tipped tines, however, it requires a claw tooth hammer for insertion and removal.

A further issue with the prior art is the ability to only hold and support light, flat articles, such as paper or the like and when the pushpin is pierced though such articles a permanent aperture(s) is created and damage to the article occurs. It would be desirable to have a pushpin that could be used for other purposes than simply supporting a flat article, such as direction or support of a wire, hanging objects, etc. Thus, multiple flexible or non flexible tines and a body with an aperture therethrough would be highly desirable to expand the uses of the pushpin. Prior art such as U.S. Pat. No. 4,955,813 to Fochler, U.S. Pat. No. 4,525,115 to Garner, Sr., U.S. Design Pat. No. D224,086 to Willis, U.S. Pat. No. 1,991,561 to Krantz, U.S. Pat. No. 2,623,431 to Scheurmann, and U.S. Pat. No. 1,076,983 to Jerrim are examples of pushpins that do not teach an aperture therethrough the body and thus cannot support an article without piercing it.

In looking at U.S. Design Pat. No. D466,937 to Kochlefl and U.S. Design Pat. No. D458,117 to Larson it could be envisioned to do more than attaching an article for display without piercing because of their inclusion of a aperture therethrough the pushpin body, however, their apertures are narrow and small and as discussed above, their two tines only provide for one way planar stability while inserting them into the surface and only double the bearing load area in piercing the article, as compared to a single tine pushpin. Further, in U.S. Pat. No. 6,126,126 to McKiernan, Jr. and United States Patent Application Publication Number 2002/0171017 to McKeirnan, Jr. et al. disclose wall tacks that have the ability to hang articles of a higher load, or penetrate a flat article, however, their bodies and tines would limit them to either support the hanging of an article or to pierce through and support a flat article, therefore limiting the scope of uses of the McKiernan, Jr. wall tacks in addition to not easily being removable and re-insertable to the surface, with the McKiernan, Jr. wall tack being more of a permanent installation to the surface.

Further, in looking at U.S. Pat. No. 6,126,126 to McKiernan, Jr. taught are multiple tines and a body that can either pierce an article or support the hanging of an article by way of the hook protruding from the wall tack body. However, the body of McKiernan, Jr. is much larger than the typical pushpin which would restrict its use to areas where more area of the surface the pushpin is penetrating is available. Furthermore, McKiernan, Jr. does not have an aperture therethrough the body with the advantages as previously described. Moreover, in McKiernan, Jr. because of the hook protruding from the body and the fixed angles of its tines, the use of a means of force for the insertion of the wall tack would be limited.

In continuing, in looking at U.S. Pat. No. 1,598,026 to Thompson disclosed is a staple with multiple tines and contains an aperture therethrough the body for the potential retention of an article to the surface. However, Thompson's body is not ergometrically conducive to manual grasping for easy insertion and removal of the staple from the surface. Also, the outward tines taught in Thompson are designed to permanently bend outward and anchor into the surface leading to more of a permanent installation of the staple. Furthermore, the staple configuration of Thompson's body and tines essentially eliminates the ability for manual insertion and removal by a user requiring the use of a hammer. In addition, in Thompson the aperture in not gauged for insertion depth to protect from crushing whatever is disposed within the aperture leading to a high probability of damaging the article as the pushpin is inserted in the surface.

Yet further, in U.S. Pat. No. 6,474,608 to Takata teaches two tines with an ergometric body including two tines that are pivotally connected at one end, wherein the tines pivot outward during insertion into the surface, thus the tines resist pullout, i.e. removal from the surface by the tines having to pivot in a reverse direction causing the tines near the pivot to move in an opposite direction against a washer which resists removal from the surface. However, Takata '608 has the drawback of requiring that the washer be adjacent to a particular point on the tines to resist pullout from the surface, and if the washer is not adjacent to the particular point on the tines there is minimal pullout resistance and addition to the mechanical complexity of the Takata '608 fixture. Also, Takata's '608 limitation to two tines only provides one way planar stability in the insertion movement into the surface and has the drawback of only having the bearing load area for a single tine to support the article, as previously discussed for the single pushpin tine's drawbacks. Furthermore, Takata '608 lacks an aperture therethrough the body and thus doesn't have the ability for expanded, non piercing use to support other than an article in the form of a sheet of paper.

Continuing, in U.S. Pat. No. 4,795,294 to Takada et al. teaches a body with at least two guide holes for receiving a fixing member, such as a set screw or nail to be driven into a surface. Thus, the body in Takada et al '294, coupled with the set screws or nails serving as its tines, together could function as a multiple tine pushpin, possessing the advantages inherent of multiple tines in the resistance to pullout area, wherein due to the design of Takada et al., '294 insertion force stability is not really an issue. However, Takada et al., '294 having nails or set screws function as tines hinders the ease of insertion, removal, and use of the pushpin as compared to that of a standard pushpin with tines, as Takada et al., '294 is more of a permanently installed device to the surface. For example, in Takada et al., '294 with the tines inserted into the surface, a user could not readily apply a manual force to pull the device out of the surface it is penetrated into. Moreover, the body taught in Takada et al. '294 lacks an aperture therethrough the body and therefore lacks the advantages as previously described.

What is needed is a three or more multiple tined pushpin with either a rigid or flexible body, depending on the particular desired use, with the flexible body allowing the tines to have angular flexibility along their longitudinal axes to further enhance the anchoring ability of the pushpin into the surface. Furthermore, the pushpin body would be highly impact resistant, and thus capable of increased use by either direct manual insertion and removal force or another means of force, such as a hammer, and because of the ability to use impact, the pushpin could have, but would not be required to have substantially round tipped tines to decrease the potential harm to the user caused by sharper tines. The high impact body of the pushpin would also alleviate the potential of the pushpin body fracturing or shattering, exposing the tines and potentially causing injury to the user or various objects. Next, the body of the pushpin would be ergometric to more comfortably facilitate the manual insertion and removal of the pushpin.

Further, the pushpin would have at least three tines to reduce the rotational movement of pierced articles, increase the load capacity of the pushpin for the article weight relative to the surface, increase the omni-directional lateral stability of the pushpin parallel to the surface while exerting insertion force to the pushpin body and optionally include an aperture therethrough the body of the pushpin to further facilitate and broaden the use of the pushpin by retaining articles to the surface without piercing, crushing, or shearing them. Finally, the pushpin can alternatively include a flexible body with tines connected to flexible elements of the body to facilitate in the pushpin the ability to manually provide a squeezing force, resulting in the tines being substantially parallel to one another lengthwise then inserting the pushpin into the surface and releasing the manual squeezing force on the body thereby allowing the tines to angle outward from one another lengthwise within the surface resulting in the pushpin substantially anchoring into the surface and better securing the article to the surface, wherein the article is either pierced by the tines and/or held by the body aperture therethrough.

### SUMMARY OF INVENTION

Broadly, the present invention is a pushpin for inserting into a surface and remaining adjacent to the surface, that includes a body having a body longitudinal axis, the body also including a first end portion and a second end portion, the body also has a middle portion disposed between the first end portion and the second end portion wherein the middle portion is sized and configured for manual grasping. Further included in the pushpin are at least three tines, each of the tines includes a proximal end portion and an opposing distal end portion with a lengthwise axis spanning therebetween, wherein each tine proximal end portion is adjacent to the second end portion, wherein each lengthwise axis is substantially parallel to the longitudinal axis and each of the tines are positioned substantially equidistant to one another.

These and other objects of the present invention will become more readily appreciated and understood from a consideration of the following detailed description of the exemplary embodiment(s) of the present invention when taken together with the accompanying drawings, in which;

### BRIEF DESCRIPTION OF DRAWINGS

FIG. 1 shows a perspective view of the pushpin apparatus;

FIG. 2 shows a side view of the pushpin apparatus;

FIG. 3 shows a top view of the pushpin apparatus;

FIG. 4 shows a bottom view of the pushpin apparatus;

FIG. 5 shows a side view of the pushpin apparatus with the aperture;

FIG. 6 shows a perspective view of an alternative embodiment of the pushpin apparatus including flexible fingers in the free state;

FIG. 7 shows a perspective view of the alternative embodiment of the pushpin apparatus including flexible fingers in the manually compressed state;

FIG. 8 shows a side view of the alternative embodiment of the pushpin apparatus including flexible fingers in the free state;

FIG. 9 shows a side view of the alternative embodiment of the pushpin apparatus including flexible fingers in the manually compressed state;

FIG. 10 shows a top view of the alternative embodiment of the pushpin apparatus including flexible fingers in the free state;

FIG. 11 shows a bottom view of the alternative embodiment of the pushpin apparatus including flexible fingers in the free state;

FIG. 12 shows a top view of the alternative embodiment of the pushpin apparatus including flexible fingers in the manually compressed state;

FIG. 13 shows a bottom view of the alternative embodiment of the pushpin apparatus including flexible fingers in the manually compressed state;

FIG. 14 shows a use view of the pushpin apparatus that is being inserted into the surface and piercing through the article therebetween, with the surface and the article in cross section;

FIG. 15 shows a use view of the alternative embodiment of the pushpin apparatus including flexible fingers that is being inserted into the surface and piercing through the article therebetween, with the surface and the article in cross section, by manually placing the pushpin flexible fingers into the compressed state;

FIG. 16 shows a use view of the alternative embodiment of the pushpin apparatus including flexible fingers that has been inserted into the surface and has pierced through the article therebetween, with the surface and the article in cross section, by manually releasing the pushpin flexible fingers into the free state resulting in substantially anchoring the article to the surface by the tines expanding outward through within the surface;

FIG. 17 shows a perspective use view of the pushpin apparatus with the tines inserted into the surface while substantially retaining a longitudinal element therethrough the aperture to the surface; and

FIG. 18 shows a perspective use view of the alternative embodiment of the pushpin apparatus including flexible fingers with the tines inserted into the surface while substantially retaining a longitudinal element therethrough the aperture to the surface.

### REFERENCE NUMBERS IN DRAWINGS

30 Pushpin apparatus
32 Surface
34 Article
36 Inserting movement of the pushpin 30 tines 82 into the surface 32
38 Remaining or keeping the pushpin 30 or 101 adjacent to the surface 32
40 Means of force for inserting the tines 82 into the surface 32
42 Force inserting the tines 82 into the surface 32
44 Body
46 Longitudinal axis of the body 44
48 First end portion of the body 44
50 Sizing and configuring of first end portion 48 of body 44 to accommodate a means of force 40
52 Second end portion of the body 44
54 Face of body second end portion 52
56 Matching of face 54 to surface 32
58 Middle portion of the body 44
60 Sizing and configuring of middle portion 58 to be a necked configuration
62 Ergometric manual grasping of the necked portion 60
64 Distance between body first end portion 48 and body second end portion 52
66 Manual grasping
67 Manual releasing
68 Sizing and configuring of the middle portion 58 for manual grasping 66
70 Aperture of body 44 therethrough
71 Slot for aperture 70
72 Longwise axis of aperture 70
74 Substantially perpendicular relationship between the aperture longwise axis 72 and the base transverse axis 106 or the longitudinal axis 46
76 Longitudinal element
78 Feeding the longitudinal element 76 through the aperture 70
80 Retention of longitudinal element 76 substantially to the surface 32 when the tines 82 are inserted 36 into the surface 32
82 Tine
84 Lengthwise axis of tine 82
86 Equidistant or selected positioning of tines 82 to one another
88 Proximal end portion of tine 82
90 Distal end portion of tine 82
92 Rounded distal end portion of tine 82
94 Omni-directional lateral stability of tines 82 substantially parallel to the surface 32, with the lateral stability helping prevent unwanted lateral movement
96 Positioning of tines 82 to provide omni-directional stability
98 Span of tine 82
100 Inserted tine 82 piercing into the surface 32
101 Pushpin apparatus flexible finger 114 alternative embodiment
102 Inserted tine 82 into the surface 32
104 Base
106 Transverse axis of base 104
108 First end planar portion of base 104
110 Second end planar portion of base 104
112 Sizing and configuring of the first end planar portion 108 to accommodate a means 40 of force
114 Flexible finger
116 Primary end portion of finger 114
118 Secondary end portion of finger 114
119 Necked portion of finger 114
120 Elongated axis of finger 114
121 Face of secondary end portion of finger 118
122 Substantially equidistant relationship of the multiple elongated axes 120 of the fingers 114
124 Substantially perpendicular plane taken through all of the elongated axes 120
125 Contact point of secondary end portions 118
126 Free state of the fingers 114
128 Compressed state manually of the fingers 114
130 Acute angle between the transverse axis 106 and the elongated axis 120 in the fingers 114 free state 126
132 Substantially parallel relationship between the transverse axis 106 and the elongated axis 120 in the fingers 114 manually compressed state 128
134 Adjacent relationship between the tine proximal end portion 88 and the finger secondary end portion 118
136 Parallel relationship between the elongated axis 120 and the lengthwise axis 84 for the flexible finger 114 and tine 82 combination
138 Grasping manually the body 44 of the pushpin 30
140 Grasping manually the fingers 114 of the pushpin 30
142 Compressing manually the flexible fingers 114 until the fingers 114 are adjacent to one another placing the fingers 114 into the compressed state 128
144 Inserting manually the tines 82 into the surface 32 while the fingers 114 remain in the compressed state 128
145 Anchoring movement of the tines 82 into the surface 32 thus substantially anchoring the pushpin 30 into the surface 32
146 Releasing manually the fingers 114 allowing the fingers 114 to go into the free state 126 with the tines 82 anchoring into the surface 32 thus anchoring 145 the pushpin 30 to the surface 32
148 Manually piercing an article 34 with the tines 82
150 Substantially securing the article 34 to the surface 32 with the pushpin 30 or pushpin 101
152 Manually removing the pushpin 30 from the surface 32 by manually placing the fingers 114 in the compressed state 128

### DETAILED DESCRIPTION

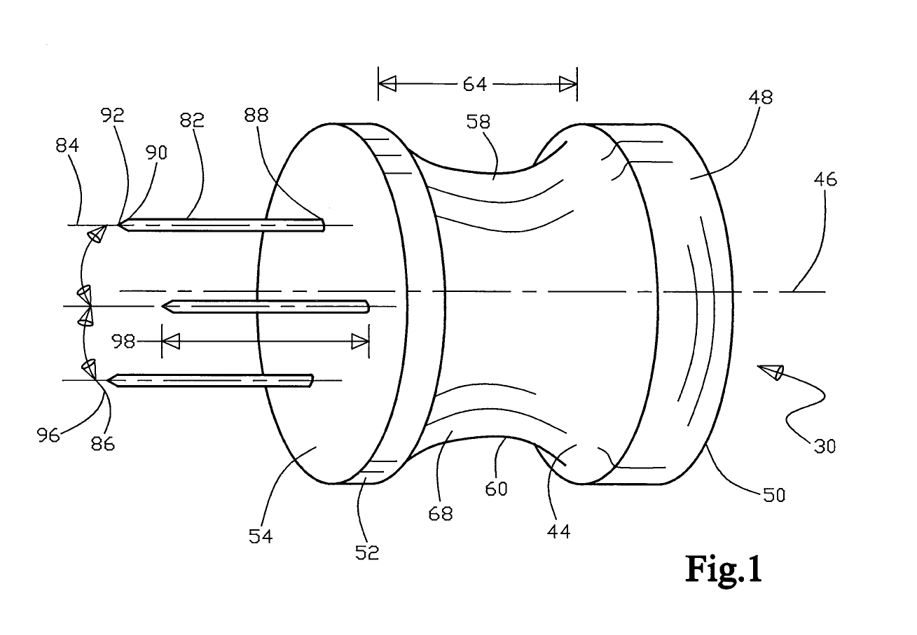

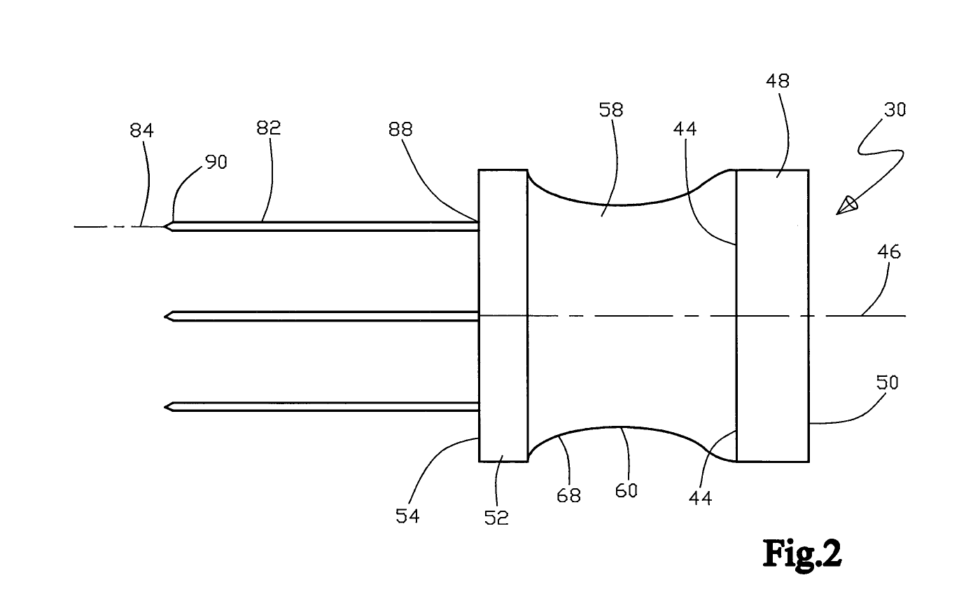

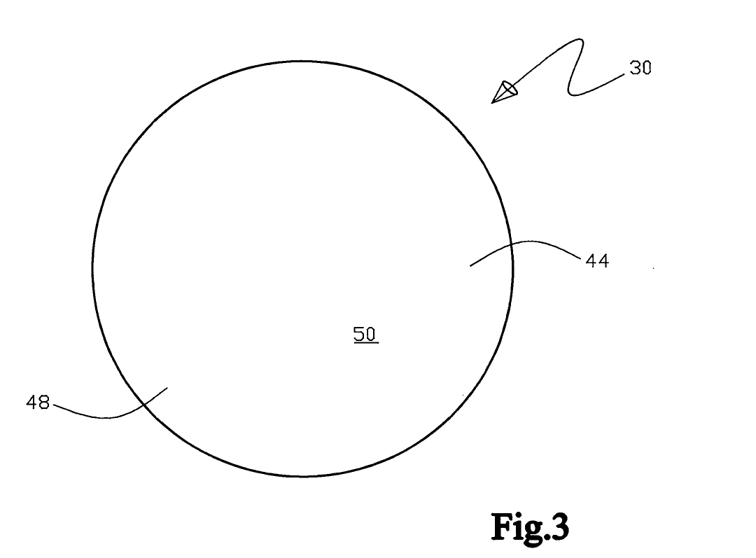

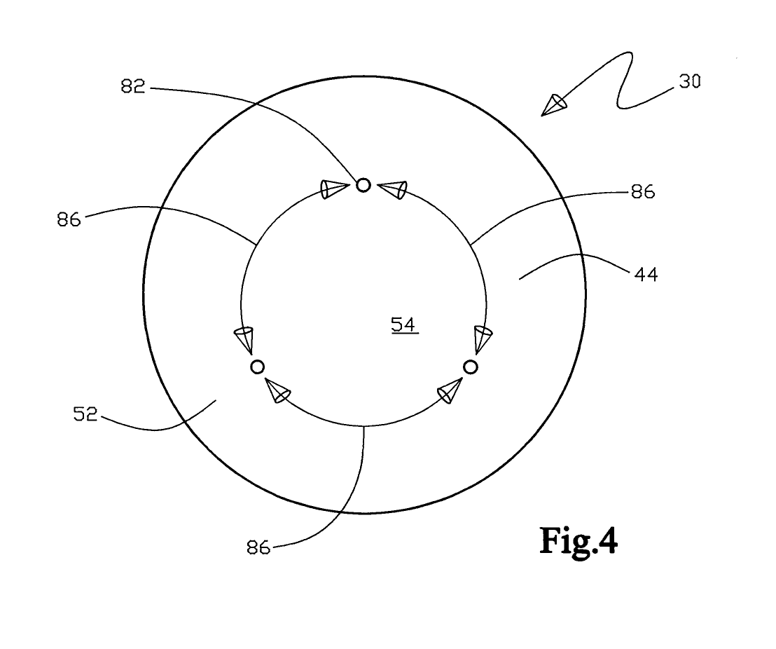

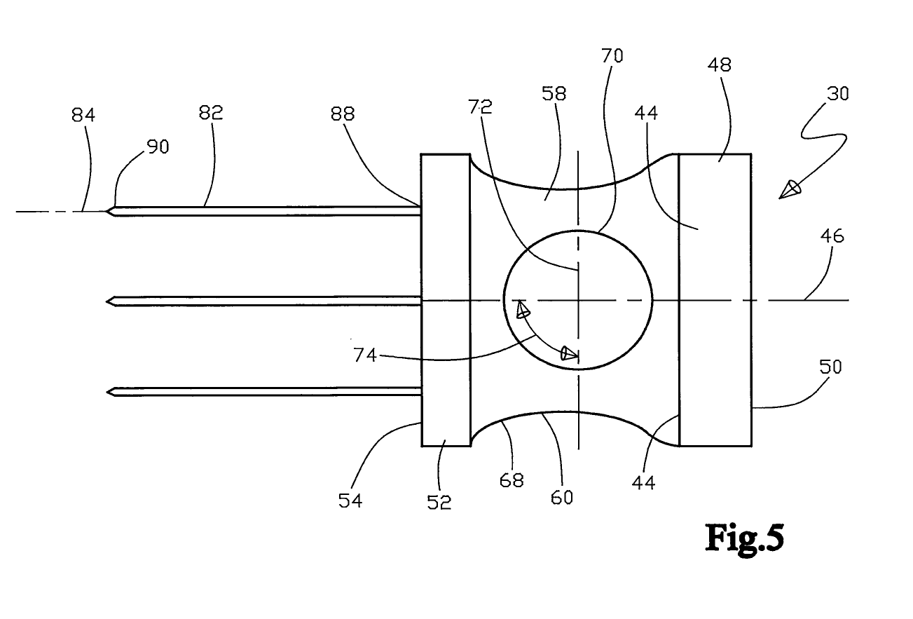

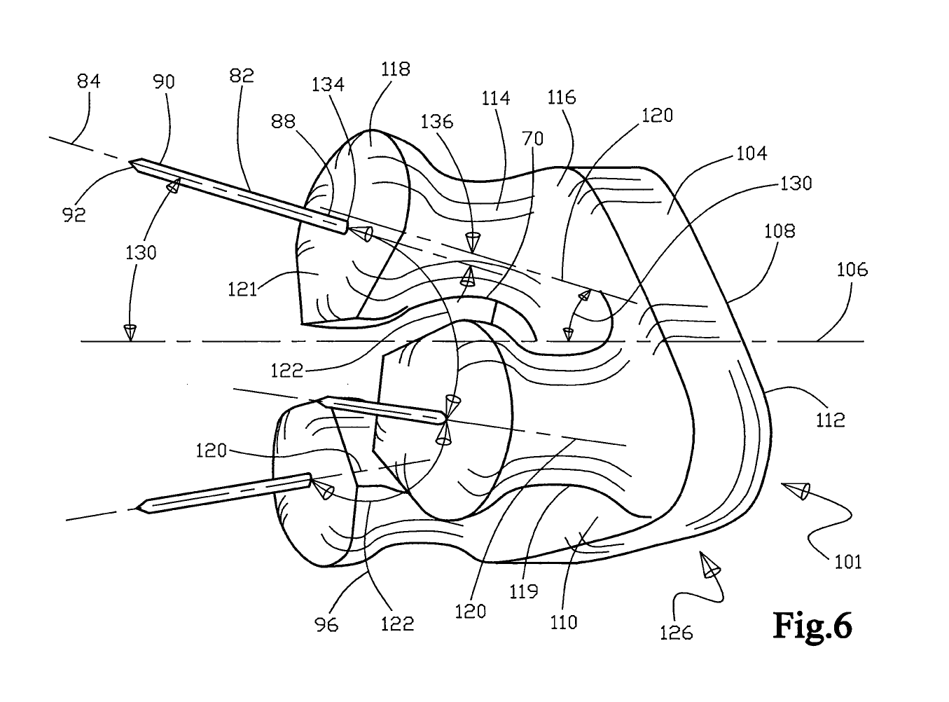

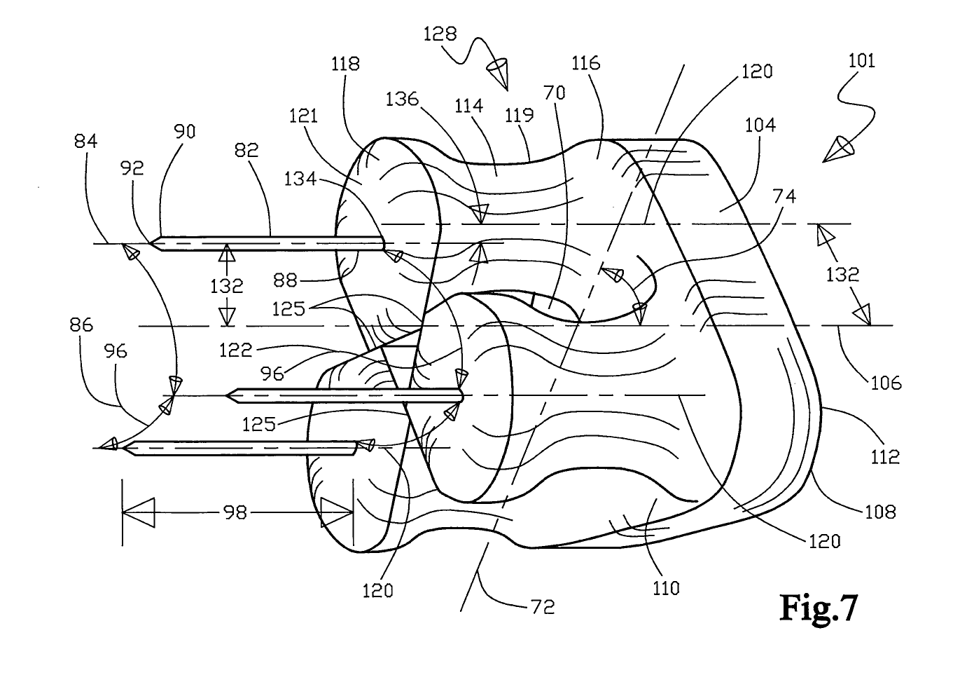

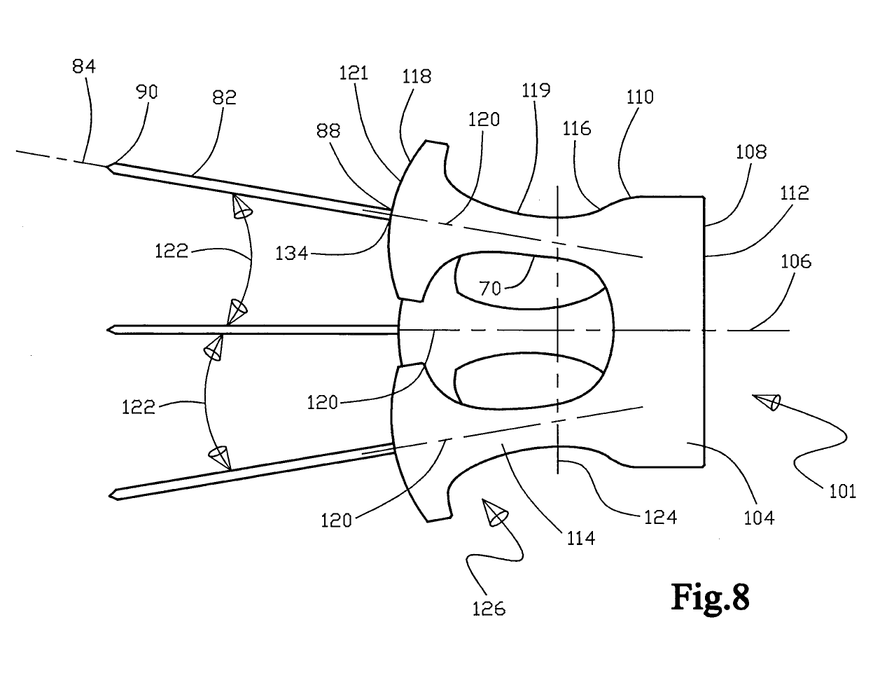

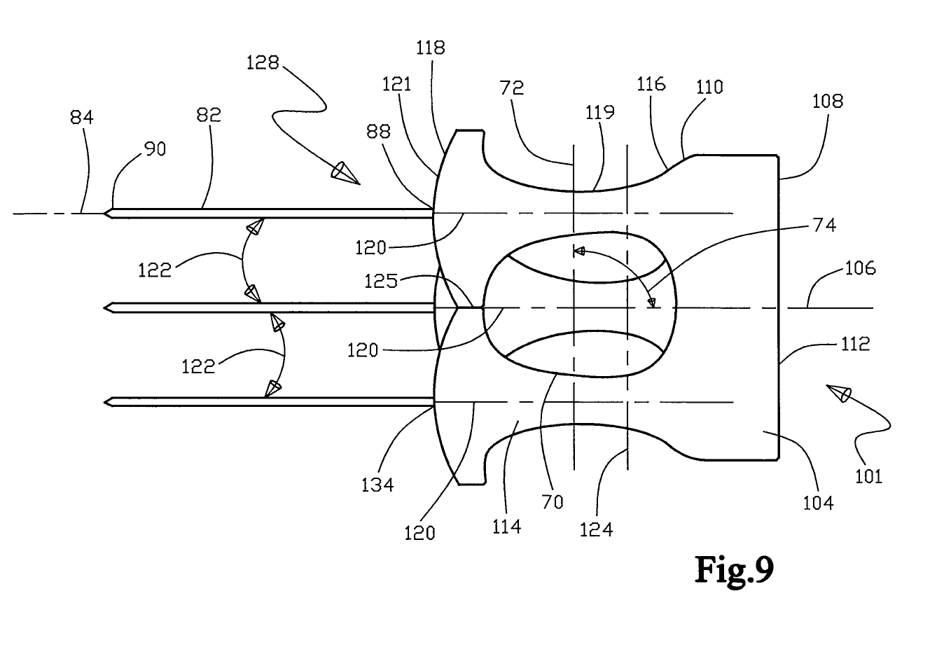

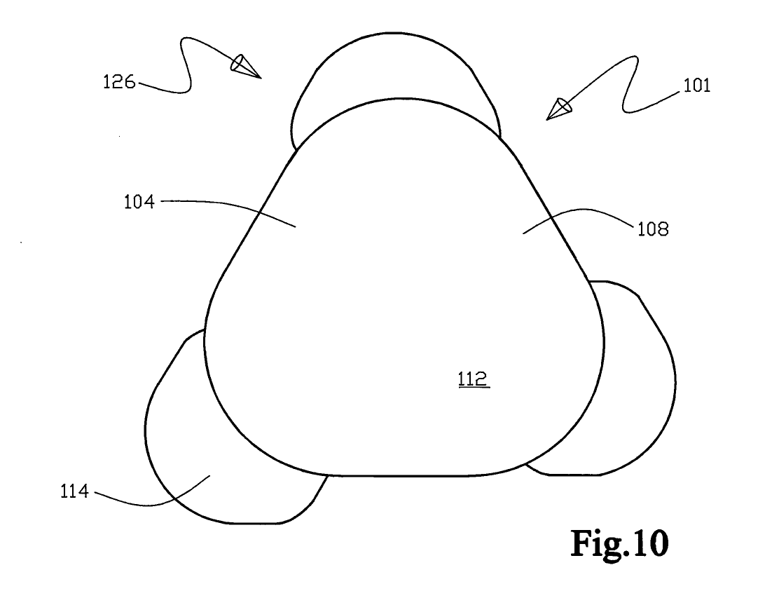

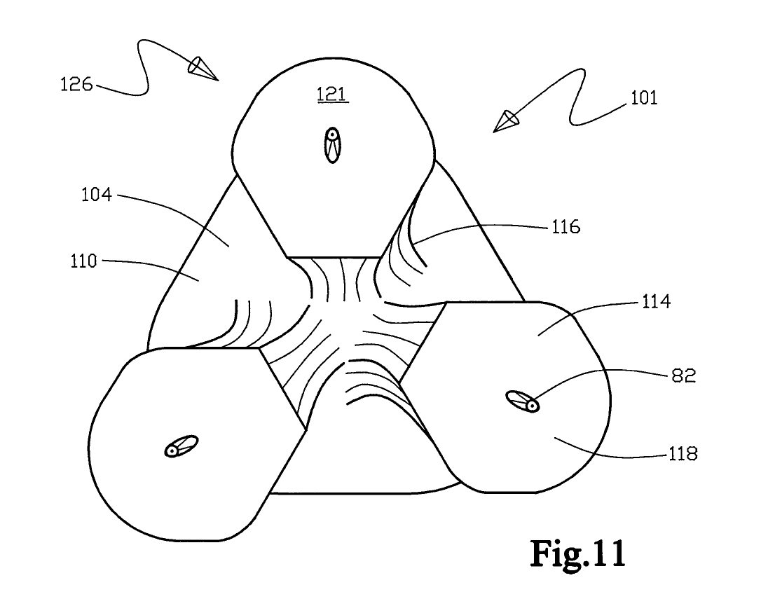

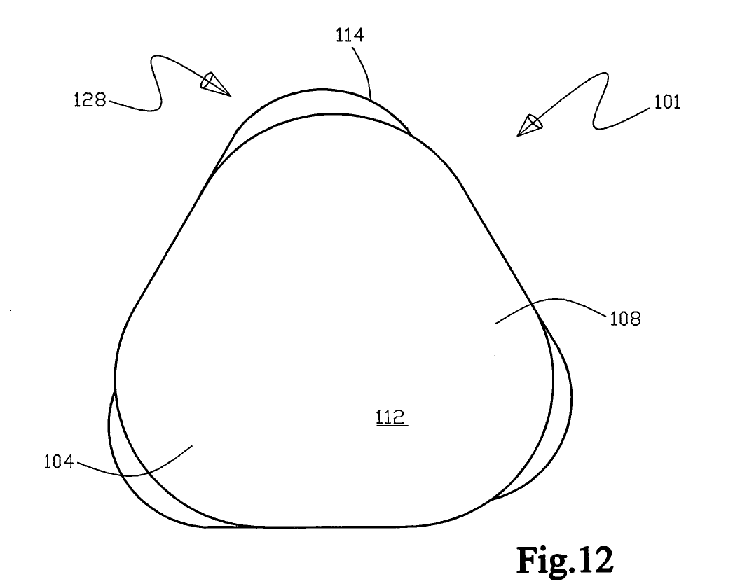

With reference to FIG. 1 shown is a perspective view of the pushpin apparatus 30, FIG. 2 shows a side view of the pushpin apparatus 30, and FIG. 3 shows a top view of the pushpin apparatus 30. FIG. 4 shows a bottom view of the pushpin apparatus 30, FIG. 5 shows a side view of the pushpin apparatus 30 with the aperture 70, and FIG. 6 shows a perspective view of the alternative embodiment of the pushpin apparatus 101 including flexible fingers 114 in the free state 126. FIG. 7 shows a perspective view of the alternative embodiment of the pushpin apparatus 101 including flexible fingers 114 in the manually compressed state 128, FIG. 8 shows a side view of the alternative embodiment of the pushpin apparatus 101 including flexible fingers 114 in the free state 126, and FIG. 9 shows a side view of the alternative embodiment of the pushpin apparatus 101 including flexible fingers 114 in the manually compressed state 128. FIG. 10 shows a top view of the alternative embodiment of the pushpin apparatus 101 including flexible fingers 114 in the free state 126, FIG. 11 shows a bottom view of the alternative embodiment of the pushpin apparatus 101 including flexible fingers 114 in the free state 126, and FIG. 12 shows a top view of the alternative embodiment of the pushpin apparatus 101 including flexible fingers 114 in the manually compressed state 128.

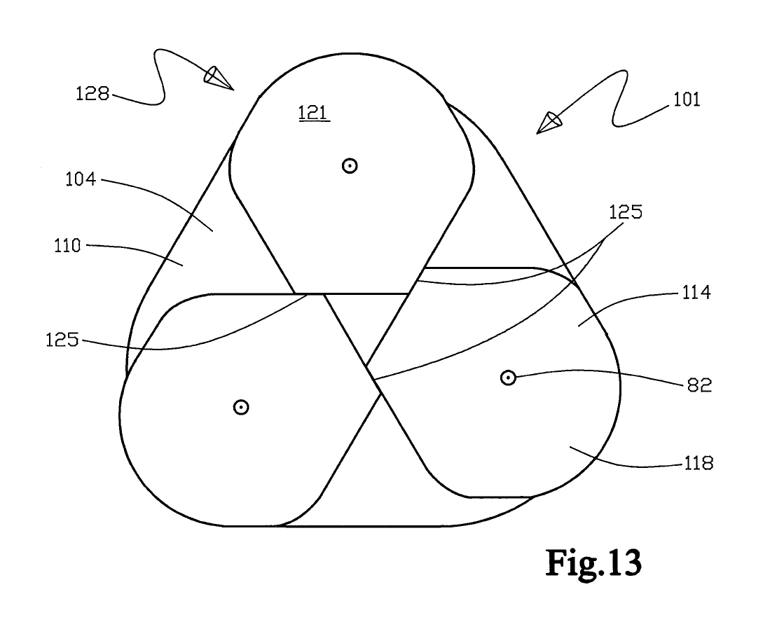

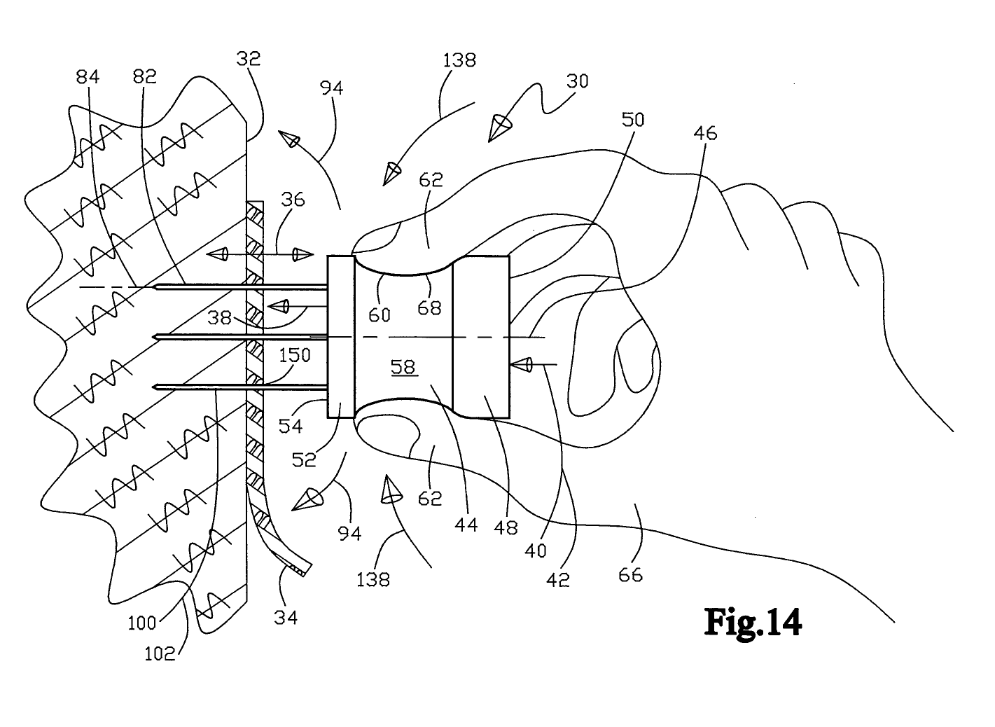

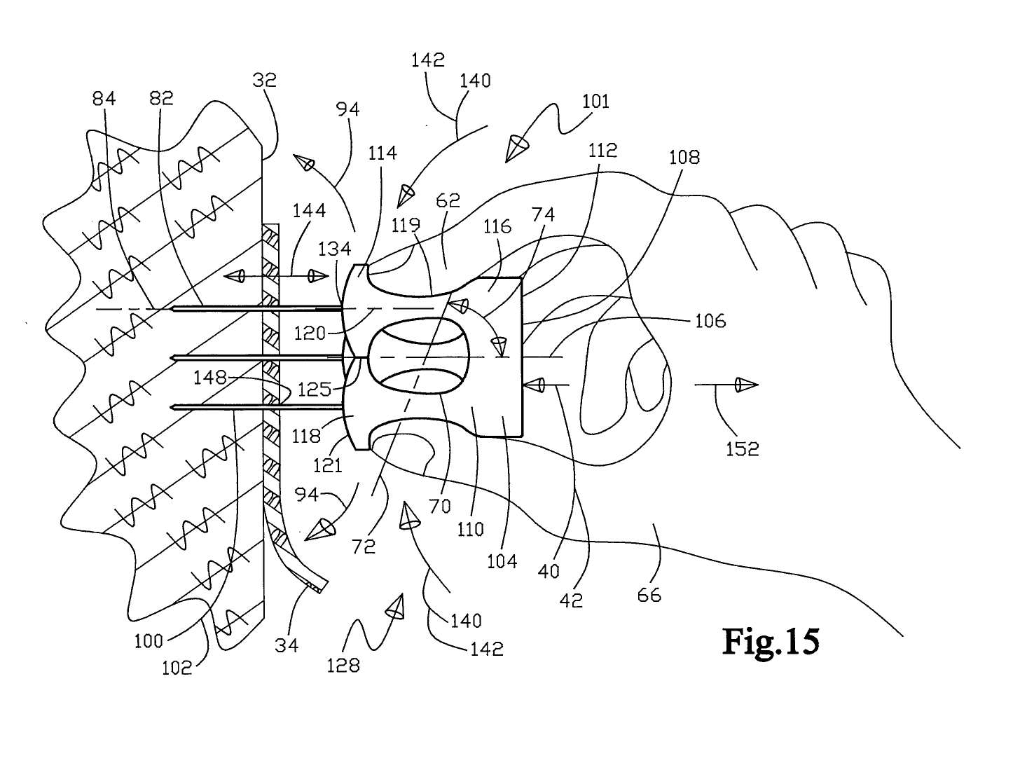

Continuing, FIG. 13 shows a bottom view of the alternative embodiment of the pushpin apparatus 101 including flexible fingers 114 in the manually compressed state 128 and FIG. 14 shows a use view of the pushpin apparatus 30 that is being inserted 36 into the surface 32 and piercing 100 through 102 the article 34 therebetween 150, with the surface 32 and the article 34 in cross section. Further, FIG. 15 shows a use view of the alternative embodiment of the pushpin apparatus 101 including flexible fingers 114 that is being inserted 144 into the surface 32 and piercing 148 through the article 34 therebetween, with the surface 32 and the article 34 in cross section, by manually 140 placing 142 the pushpin 101 flexible fingers 114 into the compressed state 128.

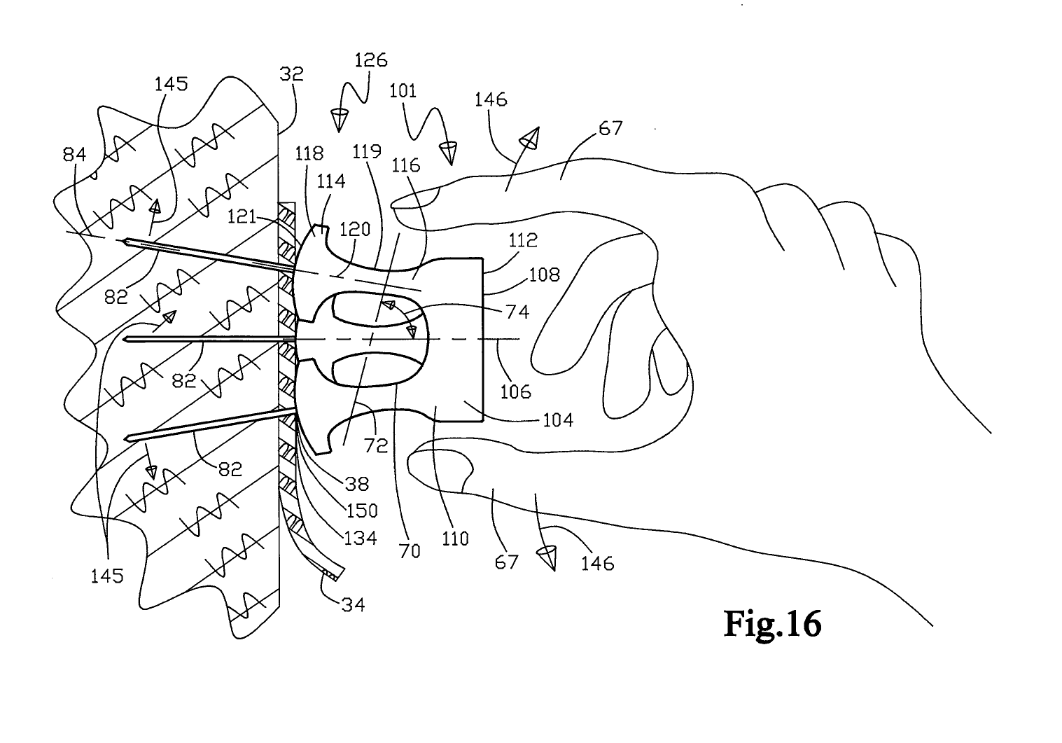

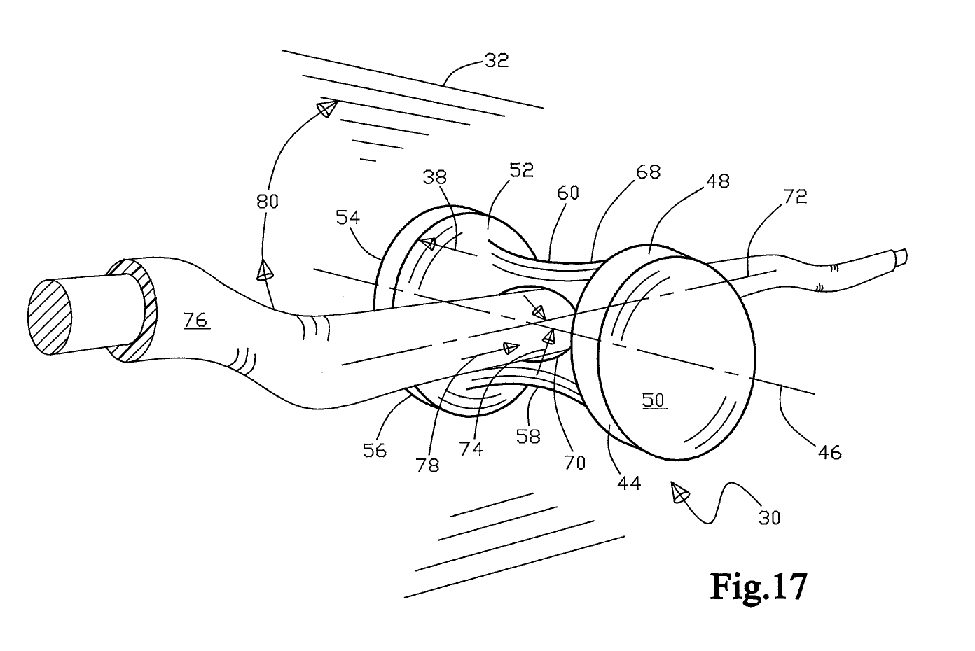

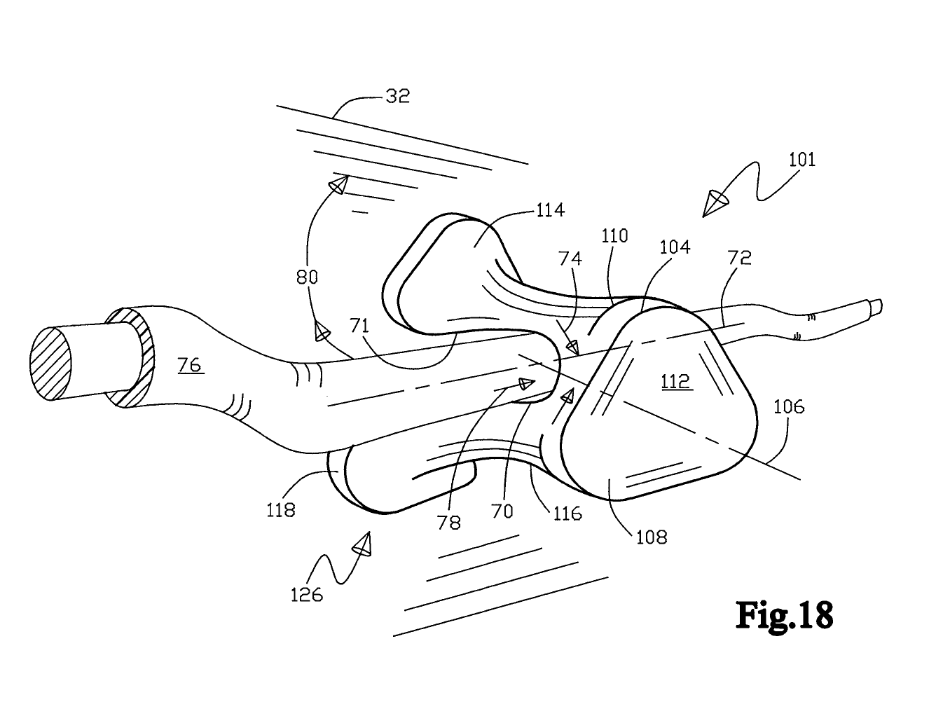

Next, FIG. 16 shows a use view of the alternative embodiment of the pushpin apparatus 101 including flexible fingers 114 that has been inserted into the surface 32 and has pierced through the article 34 therebetween, with the surface 32 and the article 34 in cross section, by manually 67 releasing 146 the pushpin flexible fingers 114 into the free state 126 resulting in substantially anchoring 145 the article 34 to the surface 32 by the tines 82 expanding outward 145 through within the surface 32. Next, FIG. 17 shows a perspective use view of the pushpin apparatus 30 with the tines (not shown) inserted into the surface 32 while substantially retaining 80 a longitudinal element 76 therethrough the aperture 70 to the surface 32. Further, FIG. 18 shows a perspective use view of the alternative embodiment of the pushpin apparatus 101 including flexible fingers 114 with the tines (not shown) inserted into the surface 32 while substantially retaining 80 a longitudinal element 76 therethrough the aperture 70 to the surface 32.

Referring to FIGS. 1 through 5 for structure, and FIGS. 14 and 17 for usage, the present invention broadly includes the pushpin 30 for inserting 100 into the surface 32 and remaining adjacent to the surface 32, that includes a body 44 having a body longitudinal axis 46, the body 44 also including a first end portion 48 and a second end portion 52, the body 44 also has a middle portion 58 disposed between the first end portion 48 and the second end portion 52 wherein the middle portion 58 is sized and configured 60 for manual grasping 62. Further included in the pushpin 30 are at least three tines 82, wherein each of the tines 82 includes a proximal end portion 88 and an opposing distal end portion 90 with a lengthwise axis 84 spanning therebetween. Each tine proximal end portion 88 is adjacent to the second end portion 52, wherein each lengthwise axis 84 is substantially parallel to the longitudinal axis 46 and each of the tines 82 are positioned substantially equidistant 86 to one another as best shown in FIGS. 1 and 4.

In referring to FIGS. 1 through 5, the pushpin 30 equidistant spacing or positioning 86 of the tines 82 are positioned in a manner that operationally provides omni-directional lateral stability 96 such that omni-directional lateral stability 94 of the tines 82 is substantially parallel to the surface 32 as best shown in FIG. 14. In other words FIG. 14 shows that the lateral stability 94 to come into play during the means for forcing 40 the tines 82 with force 42 into the surface 32 with movement 36 as best shown in FIG. 14. Thus the equidistant positioning 86 of at least three tines 82 acts to help prevent the side to side lateral type movement as indicated by 94 in FIG. 14, especially when the surface 32 is of a more dense material requiring more force 42 wherein the pushpin 30 can inadvertently move laterally 94 with a typical prior art single or double tine pushpin that can potentially cause user hand/finger injury and/or damage to the pushpin, article 34, and surface 32. Thus the current invention pushpin apparatus 30 benefits from a “tripod” type stability like a camera stand, or by adding more tines 82, such as four or five or more tines 82 for even more increased lateral stability as previously described.

As an option the pushpin 30 can have a span 98 between the tine proximal end portion 88 and the tine distal end portion 90 is about two (2) times the distance 64 between the body first end portion 48 and the body second end portion 52 as best shown in FIG. 1. This span 98 is to accommodate an article 34 of a higher thickness and/or to increase the remaining or keeping 38 of the pushpin 30 adjacent 38 to the surface 32 by having a longer insertion length acting through tine span 98 into the surface 32. The tine span 98 can be more or less than two (2) times the distance 64 to facilitate use with articles 34 or surfaces 32 that are more dense for a shorter tine span 98 or less dense for a longer tine span 98. To further accommodate thick articles 34 and/or more dense surfaces 32, alternatively the first end portion 48 can be sized and configured 50 to accommodate a means 40 of force for inserting the tines 82 into the surface 32, reference FIG. 14. Otherwise this sizing and configuring 50 can be a hardening or shaping of the first end portion for striking by a hammer for instance as the means 40 of force or similar implement thus further expanding the applications of the pushpin 30 beyond typical articles 34 of paper and typical surfaces 32 of bulletin board cork. This expanding of applications for the pushpin 30 can include more conventional “nail” like applications wherein the surface 32 could be wood, a composite, or masonry type in conjunction with or without an article 34 being present or utilizing the aperture 70, or even the body 44 to suspend or support an element 76 which can be a wire as shown in FIG. 17, or the like that could be retained 80 by the aperture 70 to the surface 32.

Continuing in this area, as an enhanced safety feature for the pushpin 30 could be wherein the tines 82 each optionally include a rounded 92 distal end portion 90, wherein the rounded 92 distal end portion 90 is operational to help reduce injury from the tine distal end portion 90, much like a blunt tip nail as opposed to the tine distal end portion 90 having a sharp tip. However, as the tine distal end portion 90 having a sharp tip that acts to reduce the force 42 to ease the inserting 36 of the tine 82 through the article 34 and/or the surface 32 with the potential drawback being the higher risk for a pricking or stabbing injury to the user's hand or otherwise. Thus with the rounded 92 distal end portion 90 being safer user injury wise, would require higher force 42 resulting in the aforementioned desired need for the sizing and configuring 50 of the first end portion 48 to accommodate a means 40 of force as previously described.

To further enhance usefulness of the pushpin 30 optionally the body 44 has the aperture 70 therethrough, see FIGS. 5 and 17, wherein the aperture 70 includes a longwise axis 72 that is substantially perpendicular 74 to the longitudinal axis 46, wherein operationally the aperture 70 substantially retains the longitudinal element 76 relative 80 to the surface 32 when the pushpin tines 82 are inserted 36 into the surface 32, as best shown in FIG. 17. Note that as a further option, to give the aperture 70 more flexibility in its application and use, in referring to FIG. 18 which is for an alternative embodiment 101 of the pushpin the aperture 70 is shown with an open access slot 71 type arrangement as facing toward the surface 32 that allows the element 76 to be feed 78 through the slot 71 in addition to the feeding 78 lengthwise through of the element 76 into the aperture 70 as shown in FIG. 17. Thus, an additional access of the element 76 into the aperture 70 of the aforementioned slot 71 could be provided for the aperture 70 of the pushpin 30, in addition the slot 71 positioning wouldn't necessarily have to be facing the surface 32 as is shown for FIG. 18, as the slot 71 could be oppositely disposed of the surface 32, being opposite from what is shown in FIG. 18, or the slot 71 could be disposed perpendicular to the position shown in FIG. 18 by coming in the side or laterally to the aperture 70 in the body 44. Therefore, the optional addition of the slot 71, i.e. in going from FIG. 17 to FIG. 18 for the pushpin 30 facilitates more options for placing the element 76 into the aperture 70 of the body 44 for the overall purpose of retaining 80 the element 76 substantially to the surface 32.

As a further enhancement to the pushpin 30 ergometrically, in referring to FIG. 1, optionally the middle portion 58 is a necked configuration 60 in-between the first end portion 48 and the second end portion 52, wherein the necked configuration 60 is operational for a more ergometric 62 manual grasping 66 or 138, from the sizing and configuring 68 as best shown in FIG. 14. This ergometric 62 necked configuration 60 further acts to allow more inserting movement 36 force 42 while having less fatigue on the users hand and fingers. Another optional enhancement of the pushpin 30 is the second end portion 52 including a face 54 that is sized and configured to match 56 the surface 32 or even the article 34 when the pushpin tines 82 are inserted 36 into the surface 32. What this results in is that the face 54 does not “cookie cut”, dimple, or harm the article 34 or surface 32 once the tines 82 are inserted 36 into the surface 32 as shown in FIGS. 14 and 17, this would suggest that the face 54 is possibly somewhat convex in profile so as not to create high bearing loads, like an edge for instance, as against the article 34 and/or surface 32.

Looking to the materials of construction for the pushpin 30, preferably the body 44 is constructed of materials selected from the group consisting essentially of plastic, carbon fiber, and fiber glass or alternatively is constructed of materials selected from the group consisting essentially of aluminum, steel, and, titanium, any other materials would be acceptable that can meet the functional requirements that the aforementioned materials are capable of. Further, the tines 82 are preferably constructed of a corrosion resistant steel, however, composite type materials would also be acceptable. Or any other materials that meet the needs of the tines 82 inserting 36 into the article 43 and/or the surface 32.

As an alternative embodiment, in referring to FIGS. 6 through 13 for the structure and FIGS. 15, 16, and 18 for the usage, the pushpin 101 for inserting 144 into the surface 32 and remaining adjacent 38 to the surface 32 is disclosed. The pushpin 101 includes a base 104 having a transverse axis 106 with the base 104 also having a first end planar portion 108 and a second end planar portion 110. Also included in the pushpin 101 are at least three flexible fingers 114 each having a primary end portion 116 and an opposing secondary end portion 118 with an elongated axis 120 spanning therebetween, with the primary end portion 116 being adjacent to the base second end planar portion 110. Each elongated axis 120 being substantially equidistant 122 from one another in a substantially perpendicular plane 124 taken through all of the elongated axes 120, the fingers 114 having a free state 126, see FIG. 6, and a manually compressed state 128, see FIG. 7. Wherein in the free state 126 each of the elongated axis 120 forms an acute angle 130 with the transverse axis 106 and in the compressed state 128 each elongated axis 120 is substantially parallel 132 to the transverse axis 106.

Further included in the pushpin 101, are at least three tines 82, each tine 82 including a proximal end portion 88 and an opposing distal end portion 90 with a lengthwise axis 84 spanning therebetween, wherein at least one tine proximal end portion 88 is adjacent 134 to each flexible finger secondary end portion 118 resulting in the elongated axis 120 and the lengthwise axis 84 being substantially parallel 136 for each given flexible finger 114 and tine 82 combination, as best shown in FIGS. 6 and 7. In addition, each tine 82 has a span 98, as best shown in FIG. 7, wherein the span 98 is preferably about equal in length to the finger 114 distance between the primary end portion 116 and the secondary end portion 118, however, with the span 98 being longer or shorter depending upon the density of the article 34 and the surface 32, which a higher density would tend toward to shorter span 98 and a lower density would tend to a longer span 98.

The spacing or positioning 86 of the tines 82 are optionally positioned 96, see FIGS. 6 and 7, in a manner that operationally provides omni-directional lateral stability 94 such that the omni directional lateral stability 94 of the tines 82 is substantially parallel to the surface 32 as best shown in FIG. 15. In other words, FIG. 15 shows that the lateral stability 94 to come into play during the means for forcing 40 the tines 82 with force 42 into the surface 32 with movement 144 as best shown in FIG. 15. Thus the positioning 86 of at least three tines 82 acts to help prevent the side to side lateral type movement as indicated by 94 in FIG. 15 especially when the surface 32 is of a more dense material requiring more force 42 wherein the pushpin 101 can inadvertently move laterally 94, with a typical prior art single or double tine pushpin that can potentially cause user hand/finger injury and/or damage to the pushpin, article 34 and surface 32. Thus the current invention pushpin apparatus 101 benefits from something similar to a “tripod” type stability like a camera stand, or by adding more tines 82, such as four or five or more tines 82 for even more increased lateral stability as previously described.

In referring in particular to FIGS. 6-13, for the pushpin 101 and in focusing upon the interaction of the fingers 114 secondary end portions 118 in going from the free state 126 in FIGS. 6, 8, 10, 11, and 16 to the compressed state 128 in FIGS. 7, 9, 12, 13, and 15 it can be observed that in the compressed state 128 that the finger secondary end portions come into contact 125 to act as a gage for the fingers 114 to contact one another in the compressed state 128. Thus the contact 125 gage furthers the functionality of the manual grasping 140 of the fingers 114 in placing the pushpin 101 into the compressed state 128 as best shown in FIG. 15 to substantially allow the lengthwise axes 84 of the tines 82 to be nearly parallel to better facilitate insertion 144 of the tines 82 into the article 34 and surface 32.

To further accommodate thick articles 34 and/or more dense surfaces 32, alternatively the first end planar portion 108 can be sized and configured 112 to accommodate a means 40 of force for inserting the tines 82 into the surface 32, reference FIG. 15. Otherwise this sizing and configuring 112 can be a hardening or shaping of the first end planar portion 108 for striking by a hammer as a means 40 of force for instance or similar implement thus further expanding the applications of the pushpin 101 beyond typical articles 34 of paper and typical surfaces 32 of bulletin board cork. This expansion of applications for the pushpin 101 are into a more conventional “nail” like applications wherein the surface 32 could be wood, a composite, or masonry type in conjunction with or without an article 34 being present or utilizing the aperture 70 or even the base 104 and fingers 114 to suspend or support an element 76 such as wire as shown in FIG. 18 or the like that could be retained 80 by the aperture 70 to the surface 32.

Continuing in this area, as an enhanced safety feature for the pushpin 101, there could be an alternative wherein the tines 82 each optionally include a rounded 92 distal end portion 90, wherein the rounded 92 distal end portion 90 is operational to help reduce injury from the tine distal end portion 90, much like a blunt tip nail as opposed to the tine distal end portion 90 having a sharp tip. However, as the tine distal end portion 90 having a sharp tip that acts to reduce the force 42 to ease the inserting 144 of the tine 82 through the article 34 and/or the surface 32 with the potential drawback being the higher risk for a pricking or stabbing injury to the user's hand or otherwise. Thus with the rounded 92 distal end portion 90 being safer user injury wise, would require higher force 42 resulting in the aforementioned desired need for the sizing and configuring 112 of the first end planar portion 108 to accommodate a means 40 of force as previously described.

To further enhance usefulness of the pushpin 101, optionally the base 104 and fingers 114 can form the aperture 70 therethrough, see FIGS. 6 through 9 and FIGS. 15, 16, and 18, wherein the aperture 70 includes a longwise axis 72 that is substantially perpendicular 74 to the transverse axis 106, in both the free state 126 and the compressed state 128, wherein operationally the aperture 70 substantially retains the longitudinal element 76 relative 80 to the surface 32 when the pushpin tines 82 are inserted 36 into the surface 32, as best shown in FIG. 18. Note that as a further option, to give the aperture 70 more flexibility in its application and use, in referring to FIG. 18 which is for an alternative embodiment 101 of the pushpin the aperture 70 is shown with an open access slot 71 type arrangement as facing toward the surface 32 that allows the element 76 to be feed 78 through the slot 71 in addition to the feeding 78 lengthwise through of the element 76 into the aperture 70 as shown in FIG. 17. Thus, an additional access of the element 76 into the aperture 70 of the aforementioned slot 71 could be provided for the aperture 70 of the pushpin 101, in addition the slot 71 positioning wouldn't necessarily have to be facing the surface 32 as is shown for FIG. 18, as the slot 71 could be oppositely disposed of the surface 32, being opposite from what is shown in FIG. 18. Therefore, the optional addition of the slot 71, as best shown in FIG. 18 for the pushpin 101 facilitates more options for placing the element 76 into the aperture 70 formed by the base 104 and fingers 114 for the overall purpose of retaining 80 the element 76 substantially to the surface 32.

As a further enhancement to the pushpin 101 ergometrically, in referring to FIGS. 5 through 8, optionally the combination of the fingers 114 and the base 104 is a necked configuration 119 between the primary end portion of the finger 116 and the secondary end portion of the finger 118, wherein the necked configuration 119 is operational for a more ergometric manual grasping 140, as best shown in FIG. 15. This ergometric necked configuration 119 further acts to allow more inserting movement 144 while having less fatigue on the users hand and fingers. Another optional enhancement of the pushpin 101 is the secondary end portion of the finger 118 including a face 121 that is sized and configured to match being adjacent 134 the surface 32 or even the article 34 when the pushpin tines 82 are inserted 144 into the surface 32. What this results in is that the face 121 does not “cookie cut”, dimple, or harm the article 34 or surface 32 once the tines 82 are inserted 36 into the surface 32 as shown in FIGS. 15 and 16, this would suggest that the face 121 is possibly somewhat convex in profile so as not to create high bearing loads, like an edge for instance, as against the article 34 and/or surface 32.

Looking to the materials of construction for the pushpin 101, preferably the fingers 114 are constructed of materials selected from the group consisting essentially of plastic, carbon fiber, and fiber glass or alternatively is constructed of materials selected from any other materials would be acceptable that can meet the functional requirements of the fingers 114 being in the free state 126 and the compressed state 128 that the aforementioned materials are capable of. Further, the tines 82 are preferably constructed of a corrosion resistant steel, however, composite type materials would also be acceptable. Or any other materials that meet the needs of the tines 82 inserting 36 into the article 43 and/or the surface 32. Further on the materials of construction on the base 104 can preferably be a match of the aforementioned finger 114 materials of construction. However, the base 104 doesn't necessarily need to be in the free state 126 or the compressed state 128 and thus having flexible materials of construction isn't necessarily needed and resulting that in the range of acceptable materials for the base 104 could be expanded into harder and more rigid materials of composites and steels which also would further accommodate the sizing and configuring 112 as previously described.

### Method of Use

Referring in particular to FIGS. 15, 16, and 18, the method of use of the alternative embodiment of the pushpin 101 is shown, that includes the steps of, providing a pushpin 101 that includes a base 104 having a transverse axis 106, the base having a first end planar portion 108 and a second end planar portion 110. The pushpin 101 also includes at least three flexible fingers 114 each having a primary end portion 116 and an opposing secondary end portion 118 with an elongated axis 120 spanning therebetween, the primary end portion 116 is adjacent to the base 104 second end planar portion 110, wherein each elongated axis 120 being substantially equidistant 122 from one another in a substantially perpendicular plane 124 taken through all of the elongated axes 120. Further in the pushpin 101 the fingers 114 having a free state 126 and a manually compressed state 128, wherein in the free state 126 each elongated axis 120 forms an acute angle 130 with the transverse axis 106 and in the compressed state 128 each elongated axis 120 is substantially parallel to the transverse axis 106.

Also included in the pushpin 101 and at least three tines 82, each tine 82 including a proximal end portion 88 and an opposing distal end portion 90 with a lengthwise axis 84 spanning therebetween, wherein at least one tine proximal end portion 88 is adjacent to each flexible finger secondary end portion 118 resulting in the elongated axis 120 and the lengthwise axis 84 being substantially parallel for each given flexible finger 114 and tine 82 combination. Further included in the pushpin 101 the base 104 and fingers 114 form an aperture 70 therethrough, wherein the aperture 70 includes a longwise axis 72 that is substantially perpendicular 74 to the base transverse axis 106 in both the finger 114 compressed state 128 and the finger free state 126, wherein operationally the aperture 70 substantially retains 80 a longitudinal element 76 relative to the surface 32 when the pushpin tines 82 are inserted into the surface 32.

Next a subsequent step of grasping manually 140 the pushpin 101 adjacent to the fingers 114, as best shown in FIG. 15, a further step of compressing 142 the flexible fingers 114 of the pushpin 101 until the fingers 114 are adjacent to one another at the contact points 125 placing the fingers 114 into the compressed state 128. Continuing, a step of inserting 144 the pushpin 101 tines 82 into the surface 32 while the fingers 114 remain in the compressed state 128, as best shown in FIG. 15. Next, a step of releasing manually 146 the pushpin 101 fingers 114, allowing the fingers 114 to move into the free state 126, as best shown in FIG. 16, wherein the tines 82 further are operational to anchor 145 the pushpin 101 into the surface 32.

Alternatively, an optional step of piercing an article 34 with the tines 82, wherein the article 34 is positioned therebetween the fingers 114 and the surface 32 before the pushpin 101 pierces or inserts 144 the surface 32, being operational for the pushpin 101 to help secure 150 the article 34 to the surface 32, as best shown in FIG. 16. Further, another optional step of feeding 78 the longitudinal element 76 through aperture 70, wherein the pushpin 101 helps retain 80 the longitudinal element 76 to the surface 32, as best shown in FIG. 18. Another optional step is of repeating the steps of grasping manually 140 and compressing 142 the flexible fingers 114 and then adding a step of removing 152 the pushpin 101 from the surface 32 while retaining the compressed state 128, as best shown in FIG. 15, paying particular attention to the removing movement 152.

### CONCLUSION

Accordingly, the present invention of a multi prong pushpin apparatus 30 and multi prong alternative embodiment pushpin apparatus including flexible fingers 101 have been described with some degree of particularity directed to the embodiment(s) of the present invention. It should be appreciated, though; that the present invention is defined by the following claims construed in light of the prior art so modifications or changes may be made to the exemplary embodiment(s) of the present invention without departing from the inventive concepts contained therein.

1. A pushpin for inserting into a surface and remaining adjacent to the surface, comprising:
(a) a body having a body longitudinal axis, said body also including a first end portion and a second end portion, said body also has a middle portion disposed between said first end portion and said second end portion wherein said middle portion is sized and configured for manual grasping; and
(b) at least three tines, each said tine including a proximal end portion and an opposing distal end portion with a lengthwise axis spanning therebetween, wherein each said tine proximal end portion is adjacent to said second end portion, wherein each said lengthwise axis is substantially parallel to said longitudinal axis and each of said tines are positioned substantially equidistant to one another.

2. A pushpin according to claim 1 wherein said tines are positioned in a manner that operationally provides omni-directional lateral stability.

3. A pushpin according to claim 1 wherein a span between said tine proximal end portion and said tine distal end portion is about two (2) times the distance between said body first end portion and said body second end portion.

4. A pushpin according to claim 1 wherein first end portion is sized and configured to accommodate a means of force for inserting said tines into the surface.

5. A pushpin according to claim 1 wherein said tines each include a rounded distal end portion, wherein said rounded distal end portion is operational to help reduce injury from the tine distal end portion.

6. A pushpin according to claim 1 wherein said body has an aperture therethrough, wherein said aperture includes a longwise axis that is substantially perpendicular to said longitudinal axis, wherein operationally said aperture substantially retains a longitudinal element relative to the surface when said pushpin tines are inserted into the surface.

7. A pushpin according to claim 1 wherein said body is constructed of materials selected from the group consisting essentially of plastic, carbon fiber, and fiber glass.

8. A pushpin according to claim 1 wherein said body is constructed of materials selected from the group consisting essentially of aluminum, steel, and, titanium.

9. A pushpin according to claim 1 wherein said middle portion is a necked configuration in-between said first end portion and said second end portion, wherein said necked configuration is operational for a more ergometric manual grasping.

10. A pushpin according to claim 1 wherein said second end portion includes a face that is sized and configured to match the surface when said pushpin tines are inserted into the surface.

11. A pushpin for inserting into a surface and remaining adjacent to the surface, comprising:
(a) a base having a transverse axis, said base having a first end planar portion and a second end planar portion;
(b) at least three flexible fingers each having a primary end portion and an opposing secondary end portion with an elongated axis spanning therebetween, said primary end portion is adjacent to said base second end planar portion, wherein each said elongated axis being substantially equidistant from one another in a substantially perpendicular plane taken through all of said elongated axes, said fingers having a free state and a manually compressed state, wherein in said free state each said elongated axis forms an acute angle with said transverse axis and in said compressed state each said elongated axis is substantially parallel to said transverse axis; and
(c) at least three tines, each said tine including a proximal end portion and an opposing distal end portion with a lengthwise axis spanning therebetween, wherein at least one said tine proximal end portion is adjacent to each said flexible finger secondary end portion resulting in said elongated axis and said lengthwise axis being substantially parallel for each given flexible finger and tine combination.

12. A pushpin according to claim 11 wherein said tines are positioned in a manner that provides for omni-directional lateral stability substantially parallel to the surface when said pushpin in experiencing an insertion force to have said tines pierce into the surface.

13. A pushpin according to claim 11 wherein said first end planar portion is sized and configured to accommodate a means of force for inserting said tines into the surface.

14. A pushpin according to claim 11 wherein each said tine distal end portion has a rounded configuration, wherein said rounded configuration is operational to help reduce injury from the said tine distal end portion.

15. A pushpin according to claim 11 wherein said flexible fingers are constructed of materials selected from the group consisting essentially of plastic, carbon fiber, and fiber glass.

16. A pushpin according to claim 11 wherein said base and fingers form an aperture therethrough, wherein said aperture includes a longwise axis that is substantially perpendicular to said base transverse axis in both said finger compressed state and said finger free state, wherein operationally said aperture substantially retains a longitudinal element relative to the surface when said pushpin tines are inserted into the surface.

17. A method for using a pushpin, comprising the steps of:
(a) providing a pushpin that includes a base having a transverse axis, said base having a first end planar portion and a second end planar portion, said pushpin also includes at least three flexible fingers each having a primary end portion and an opposing secondary end portion with an elongated axis spanning therebetween, said primary end portion is adjacent to said base second end planar portion, wherein each said elongated axis being substantially equidistant from one another in a substantially perpendicular plane taken through all of said elongated axes, said fingers having a free state and a manually compressed state, wherein in said free state each said elongated axis forms an acute angle with said transverse axis and in said compressed state each said elongated axis is substantially parallel to said transverse axis, and at least three tines, each said tine including a proximal end portion and an opposing distal end portion with a lengthwise axis spanning therebetween, wherein at least one said tine proximal end portion is adjacent to each said flexible finger secondary end portion resulting in said elongated axis and said lengthwise axis being substantially parallel for each given flexible finger and tine combination, in addition, said base and fingers form an aperture therethrough, wherein said aperture includes a longwise axis that is substantially perpendicular to said base transverse axis in both said finger compressed state and said finger free state, wherein operationally said aperture substantially retains a longitudinal element relative to the surface when said pushpin tines are inserted into the surface;
(b) grasping manually said pushpin adjacent to said fingers;
(c) compressing said flexible fingers of the pushpin until said fingers are adjacent to one another placing said fingers into said compressed state;
(d) inserting said pushpin tines into the surface while said fingers remain in said compressed state; and
(e) releasing manually said pushpin fingers, allowing said fingers to move into said free state, wherein said tines further are operational to anchor said pushpin into the surface.

18. A method for using a pushpin according to claim 17, further including a step of piercing an article with said tines, wherein the article is positioned therebetween said fingers and the surface before said pushpin pierces the surface, being operational for said pushpin to help secure the article to the surface.

19. A method for using a pushpin according to claim 17, further comprising a step of feeding a longitudinal element through said aperture, wherein said pushpin helps retain the longitudinal element to the surface.

20. A method for using a pushpin according to claim 17, further comprising a step of repeating said steps (b) and (c) and then adding a step of removing said pushpin from the surface while retaining said compressed state.
